(19) United States
(12) Patent Application Publication
(10) Pub. No.: US 2007/0162682 A1
(43) Pub. Date: Jul. 12, 2007

(54) Memory controller

(76) Inventor: Shinichi Abe, Saitama (JP)

Correspondence Address: MCDERMOTT WILL & EMERY LLP, 600 13TH STREET, N.W., WASHINGTON, DC, 20005-3096, US

(21) Appl. No.: 11/642,727

(22) Filed: Dec. 21, 2006

(30) Foreign Application Priority Data
Jan. 11, 2006 (JP) 2006-003877

(51) Int. Cl. G06F 12/06; G06F 13/00

(52) U.S. Cl. 711/5; 711/154

(57) ABSTRACT

Reference number 21 indicates a CPU, reference number 22 indicates a memory controller, and reference number 23 indicates a parameter set register group that has access parameters shared and used by banks. In the parameter set register group 23, parameter sets S0 to Sn having elements P0 to Pn exist. Reference number 24 indicates an external memory group to be finally accessed. A parameter set selection register 27 selects a parameter set among the parameter sets S0 to Sn of the parameter set register group 23 so as to be corresponded to each bank. The parameter set selection register 27 stores a unique identifier for each of banks B0 to Bm, which select the parameter sets S0 to Sn.

### BACKGROUND OF THE INVENTION

1. Field of the Invention

The present invention relates to a memory controller that accesses an external memory space through a plurality of banks. More specifically, the present invention relates to a device that can switch an access mode using a small physical resource or a few software codes.

2. Description of the Related Art

A general memory controller according to the related art will be described with reference to FIG. 1. Reference number 1 indicates a CPU, reference number 2 indicates a memory controller, reference number 3 indicates a register group that has dedicated access parameters for each bank, and reference number 4 indicates an external memory group to be finally accessed. Specifically, the access parameter is used to define a synchronous/asynchronous mode, an AC parameter that determines an access waveform, polarity of an external control signal, or the number of external bursts.

A master of the CPU 1 accesses the memory controller 2 through a slave bus 5. The register group 3 uses a slave bus 6 which is different from the slave bus 5 and the CPU 1 sets parameters for the register group 3. The memory controller 2 obtains access parameters for every bank stored in the register group 3 through a control line 7 and accesses the external memory group 4 on the basis of an access mode determined by the access parameters.

However, a memory controller according to the related art should independently hold access parameters for every memory bank in which an external access space is divided. For example, a dedicated register for the access parameter should be prepared even when a bank is not used, which causes the physical resource efficiency to be deteriorated. Further, when an access mode of a target bank is dynamically switched, a register set value corresponding to the access parameter of the corresponding bank should be individually changed at the point of switching time. Therefore, it is difficult to simultaneously reflect elements included in the access parameter to an actual external memory. Further, whenever an access mode is temporally changed and returned to an original access mode, a parameter of a corresponding bank should be changed, thereby increasing a code amount of control software.

### SUMMARY OF THE INVENTION

The invention has been finalized in consideration of the above-described problems, and it is an object of the invention to switch an access mode of an external memory by using a small physical resource or a few software codes when accessing the external memory space through a plurality of banks.

In order to solve the above-mentioned problems, the access parameters are held in a register in the form of a parameter set, that is, a table which can be shared and used by external access banks, such that a parameter set to be used by a corresponding bank is selected.

It is possible to designate the same parameter set with respect to different external banks. A register which selects a parameter set is allocated in the same space with an external memory space. The register is synchronized when the actual memory is accessed so as to be simultaneously switched with the actual memory. Further, as an application, a parameter set can be selected by setting in a software manner and the sequence can be controlled in association with an access bandwidth or a power saving mode in a hardware manner.

In order to achieve the above-mentioned object, according to an aspect of the invention, there is provided a memory system that divides a memory space to be accessed by a CPU into a plurality of banks and accesses each bank on the basis of an access mode determined by a parameter set corresponding to each bank. The memory system includes a parameter set register that stores the parameter set in the form of a table capable of being commonly used in each bank, and a memory controller that selects a parameter set corresponding to each bank from the parameter set register and sets an access mode for each bank. According to this configuration, since the parameter sets set beforehand are provided to be shared and selected by the bank, it is unnecessary to prepare parameter sets dedicated to each bank. Therefore, it is possible to reduce an implementation area.

The memory controller may include a parameter set selection register which stores an identifier of the parameter set corresponding to each bank. According to this configuration, even when the access mode is temporarily changed and then returned to the original access mode, since the selection of the parameter set is changed when changing the access mode, it is unnecessary to rewrite the parameter set itself. Therefore, the amount of codes of the control software can be reduced.

The parameter set selection register may be set in a non-defined area in the memory space. According to this configuration, the parameter set selection register is allocated on the bus which is the same as the external space, that is, a non-defined random space. Therefore, on the basis of selected parameters, it is possible to change an external access mode while synchronizing an actual external access transaction.

The memory system may further include a first bus that is used for the CPU to access the parameter set register and a second bus that is used for the CPU to access the parameter set selection register. According to this configuration, since the parameter set register can be controlled independently from the parameter set selection register, the parameter set can be easily set and controlled.

The CPU may asynchronously and independently access the parameter set register and the parameter set selection register through the first and second buses. According to this configuration, since the parameter set register and the parameter set selection register are asynchronously and independently accessed, the parameter set can be set and selected at a high speed.

The number of parameter sets may be smaller than the number of banks. According to this configuration, since the number of parameters ‘n+1’ is smaller than the number of banks ‘m+1’, an implementation area which is necessary for the parameter set register can be reduced. In this case, it is assumed that the same parameter set is set to the banks different from each other.

In the parameter set register, a parameter set of which utilization is estimated beforehand may be set as an initial value. According to this configuration, since a parameter set of an access mode to be frequently used is set as an initial value beforehand, a labor for setting the parameter due to a software control is reduced. Therefore, the amount of the software code can be reduced.

The initial value may be the parameter set corresponding to a low speed mode. According to this configuration, since the parameter set corresponding to a low speed mode is set to the initial value, a starting-up process can be smoothly processed.

The memory system may include a ROM that stores a parameter set of which utilization is estimated beforehand. According to this configuration, since the parameter set estimated to be used is stored in the ROM beforehand, the memory space can be saved.

The memory controller may further include a bandwidth detecting circuit that detects an access frequency of the CPU to the bank and selects the parameter set on the basis of the access frequency. According to this configuration, since the registration number of transactions requested from the slave bus is observed and an access mode optimized to the access frequency and the bandwidth is selected, a high or low speed access mode can be smoothly switched in accordance that the access frequency increases or decreases.

The memory controller may further include a bandwidth detecting circuit that detects an access frequency of the CPU to the bank and changes a set value of the parameter set selection register on the basis of the access frequency. According to this configuration, since a sequence control is performed in association with an access band width in a hardware manner, a large control effect can be improved.

The memory controller may further include a power saving mode control circuit that, in a power saving mode, selects an access mode corresponding to the power saving mode. According to this configuration, since an access mode optimized to the power saving mode is selected, it is possible to smoothly change to an access mode corresponding to the power saving mode.

The memory controller may further include an access mode sequencer that holds a sequence for switching an access mode to the bank in accordance with a predetermined event. According to this configuration, since the sequence for switching an access mode to the bank in accordance with a predetermined event is hold, an access mode optimized to each event can be set.

The memory controller may further include an event trigger register that detects an event and informs the access mode sequencer of timing for switching the bank. According to this configuration, a memory interface that has a plurality of parameters defining an access mode and a plurality of banks to be accessed thereby having complicated configuration can be realized by using a simple configuration.

According to another aspect of the invention, there is provided a memory controller that divides a memory space to be accessed by a CPU into a plurality of banks and accesses each bank on the basis of an access mode determined by a parameter set corresponding to each bank. The memory controller includes a register that selects a parameter set corresponding to each bank from a parameter set register which stores the parameter set in the form of a table capable of being commonly used in each bank, and sets an access mode for each bank. According to this configuration, since the prescribed parameter sets is set to be shared by the bank and selected by each bank, the access mode can be switched by using a small physical resource or a few software codes.

The memory controller may further include the parameter set selection register that stores an identifier of the parameter set corresponding to each bank. According this configuration, since the set of elements included in the parameter set is individually changed when the access mode is changed according to the related art, it is difficult to simultaneously change the parameters. However, according to the invention, it is possible to simultaneously switch the parameter prepared beforehand.

According to the invention, since the parameter sets set beforehand are provided to be shared and selected by each external bank, it is unnecessary to prepare parameter sets dedicated to each bank and an implementation area can be reduced. Even when the access mode is temporarily changed and then returned to the original access mode, the selection of the parameter set is changed when changing the access mode. Therefore, it is unnecessary to rewrite the parameter set and the amount of codes of the control software can be reduced.

According to the related art, since the set of the elements included in the parameter set is individually changed when changing the access mode, it is difficult to simultaneously change the parameter. However, according to the invention, it is possible to simultaneously switch the parameter prepared beforehand. Further, since a sequence control is performed in association with an internal state, such as access bandwidth from internal or a power saving mode, in a hardware manner, a large control effect can be improved.

### BRIEF DESCRIPTION OF THE DRAWINGS

FIG. 1 is a block diagram illustrating a general memory controller according to the related art.

FIG. 2 is a block diagram showing first and second embodiments of the invention.

FIG. 3 is a view illustrating an address map exemplifying a parameter set selection register allocated in an actual external memory space.

FIG. 4 is a block diagram illustrating a third embodiment of the invention.

FIG. 5 is a block diagram illustrating a fourth embodiment of the invention.

FIG. 6 is a block diagram illustrating a fifth embodiment of the invention.

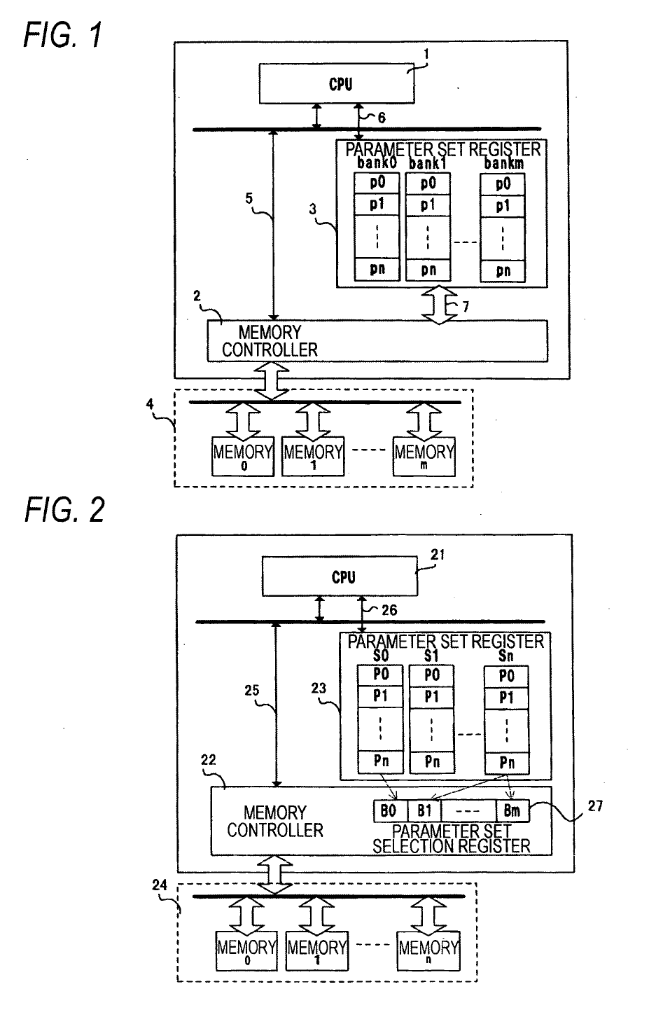

### DESCRIPTION OF THE PREFERRED EMBODIMENTS

### First Embodiment

FIG. 2 is a block diagram illustrating a first embodiment of the invention. Reference number 21 indicates a CPU, reference number 22 indicates a memory controller, and reference number 23 indicates a parameter set register group that has access parameters shared and used by banks. In the parameter set register group 23; parameter sets S0 to Sn having elements P0 to Pn exist. Reference number 24 indicates an external memory group to be finally accessed. Elements corresponding to P0 to Pn of the access parameters define a synchronous/asynchronous mode, an AC parameter which determines an access waveform, polarity of an external control signal, the number of external bursts, and so on. A master of the CPU 21 accesses the memory controller 22 through a slave bus 25. The CPU 21 sets parameters of the register group 23 through a slayer bus 26 which is different from the slave bus 25. A parameter set selection register 27 selects a parameter set among the parameter sets S0 to Sn of the parameter set register group 23 so as to correspond to each bank. The parameter set selection register 27 stores a unique identifier for each of banks B0 to Bm, which select the parameter sets S0 to Sn. In this embodiment, it is shown that the number of parameter sets is ‘n+1’ and the number of banks is ‘m+1’. However, the number of parameter sets does not need to be match with the number of banks. The external memory group 24 is accessed-on the basis of an access mode which is different for every bank determined by the parameter set selection register 27 or on the basis of the same access mode according to the selection. If the number of parameter sets ‘n+1’ is smaller than the number of banks ‘m+1’, it is possible to reduce an implementation area which is necessary for the parameter set register. In this case, it is assumed that the same parameter set is set to the banks different from each other.

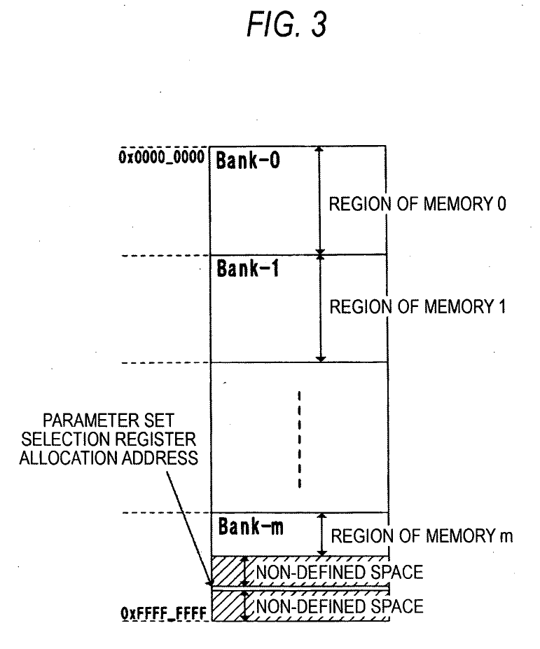

FIG. 3 shows an address map exemplifying the parameter set selection register allocated in the external memory space. In FIG. 3, external memory banks are allocated memory regions 0 to m. However, the parameter set selection registers are allocated on the same bus as the external space, that is, a non-defined random space. Therefore, an external access mode can be temporally changed on the basis of selected parameters, while being synchronized with an actual external access transaction.

### Second Embodiment

A second embodiment will be described with reference to FIG. 2. The entire construction is the same as the first embodiment. However, a labor for setting the parameter due to a software control is reduced in the parameter set registers S0 to S1 by holding the frequently used parameter set of the access mode as an initial reset value or storing it in a ROM beforehand. Therefore, the amount of the software codes is reduced. In this case, it is recommended that entire banks S0 are selected as the initial reset value of the parameter set selection register and parameter set of the bank S0 is set to correspond to a low speed mode when starting up. Further, a part of the parameter sets can be stored in the ROM so as to be statically used.

### Third Embodiment

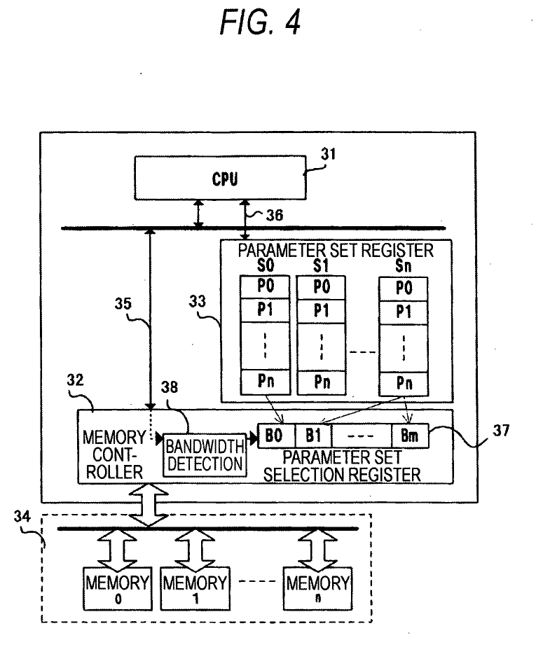

FIG. 4 is a block diagram illustrating a third embodiment of the invention. Reference number 31 indicates a CPU, reference number 32 indicates a memory controller, reference number 33 indicates a parameter set register group that has access parameters shared and used by banks. In the parameter set register group 33, parameter sets S0 to Sn having elements P0 to Pn exist. Reference number 34 indicates an external memory group to be finally accessed. Elements corresponding to the elements P0 to Pn define a synchronous/asynchronous mode, the access parameter, an AC parameter which determines an access waveform, polarity of an external control signal, the number of external burst, and so on.

A master of the CPU 31 accesses a memory controller 32 through a slave bus 35. The CPU 31 sets parameters of the register group 33 through a slayer bus 36 which is different from the slave bus 35. A parameter set selection register 37 selects a parameter set among the parameter sets S0 to Sn of the parameter set register group 33 so as to be corresponded to each bank. The parameter set selection register 37 stores a unique identifier for each of banks B0 to Bm, which select the parameter sets S0 to Sn. In this embodiment, it is shown that the number of parameter sets is ‘n+1’, and the number of banks is ‘m+1’. However, the number of parameter sets does not need to be match with the number of banks. The external memory group 34 is accessed on the basis of an access mode which is different for every bank determined by the parameter set selection register 37 or on the basis of the same access mode according to the selection.

In the memory controller 32, a bandwidth detecting circuit 38 is provided to detect an access frequency to an external memory from the CPU 31 through the slave bus 35. The bandwidth detecting circuit 38 observes the registration number of transactions requested from the slave bus 35, selects an access mode optimized to the access frequency and the bandwidth, and forcibly changes a value set in the parameter set selection register. Therefore, it is possible to smoothly switch a high or low speed access mode in accordance that the access frequency increases or decreases. When a plurality of parameter set selection registers are prepared in accordance that the access frequency increases or decreases, any one of the parameter set selection registers may be selected for the control.

### Fourth Embodiment

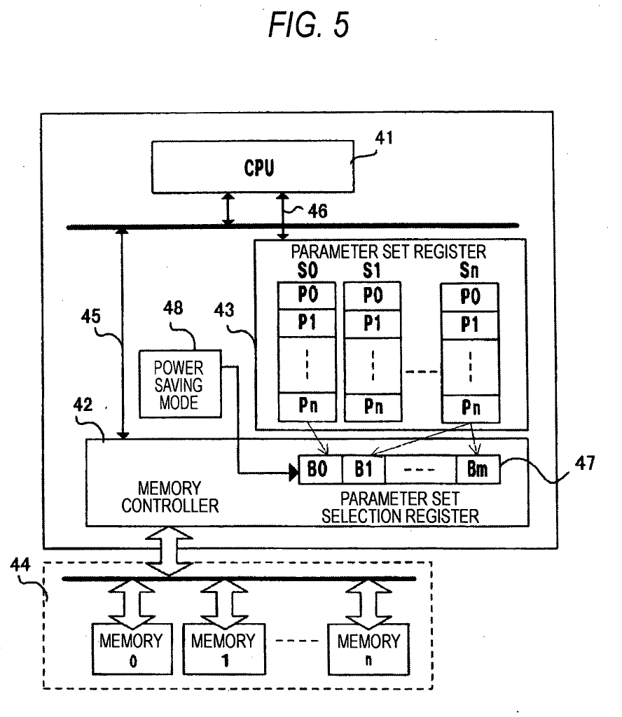

FIG. 5 is a block diagram illustrating a fourth embodiment of the invention. Reference number 41 indicates a CPU, reference number 42 indicates a memory controller, reference number 43 indicates a parameter set register group that has access parameters shared and used by banks. In the parameter set register group 43, parameter sets S0 to Sn having elements P0 to Pn exist. Reference number 44 indicates an external memory group to be finally accessed. Elements corresponding to the elements P0 to Pn define a synchronous/asynchronous mode, an AC parameter which determines an access waveform, polarity of an external control signal, the number of external bursts, and so on.

A master of the CPU 41 accesses a memory controller 42 through a slave bus 45. The CPU 31 sets parameters of the register group 43 through a slayer bus 46 which is different from the slave bus 45. A parameter set selection register 47 selects a parameter set among the parameter sets S0 to Sn of the parameter set register group 43 so as to be corresponded to each bank. The parameter set selection register 47 stores a unique identifier for each of banks B0 to Bm, which select the parameter sets S0 to Sn. In this embodiment, it is shown that the number of parameter sets is ‘n+1’ and the number of banks is ‘m+1’. However, the number of parameter sets does not need to be match with the number of banks. The external memory group 44 is accessed on the basis of an access mode which is different for every bank determined by the parameter set selection register 47 or on the basis of the same access mode according to the selection.

In addition, a power saving mode identification signal is input to the memory controller 42 from a power saving mode control circuit so as to select an optimum access mode in case of the power saving mode and forcibly change a value set in the parameter set selection register. Therefore, a mode can be smoothly switched to an access mode corresponding to the power saving mode. When additional parameter set selection registers corresponding to the power saving mode are prepared, any one of the parameter set selection registers may be selected for the control.

### Fifth Embodiment

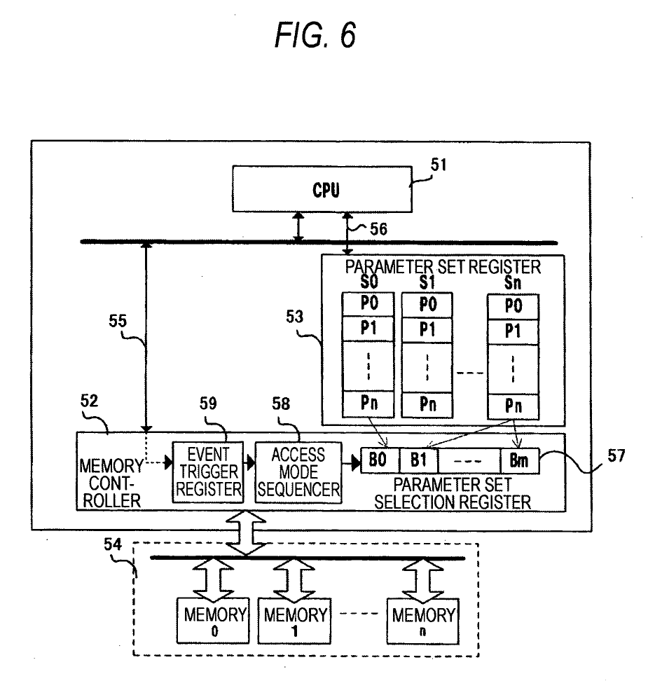

FIG. 6 is a block diagram illustrating a fifth embodiment of the invention. Reference number 51 indicates a CPU, reference number 52 indicates a memory controller, reference number 53 indicates a parameter set register group that has access parameters shared and used by banks. In the parameter set register group 53, parameter sets S0 to Sn having elements P0 to Pn exist. Reference number 54 indicates an external memory group to be finally accessed. Elements corresponding to the elements P0 to Pn define a synchronous/asynchronous mode, the access parameter, an AC parameter which determines an access waveform, polarity of an external control signal, the number of external burst, and so on.

A master of the CPU 51 accesses a memory controller 52 through a slave bus 55. The CPU 51 sets parameters of the register group 53 through a slayer bus 56 which is different from the slave bus 55. A parameter set selection register 57 selects a parameter set among the parameter sets S0 to Sn of the parameter set register group 53 so as to be corresponded to each bank. The parameter set selection register 57 stores a unique identifier for each of banks B0 to Bm, which select the parameter sets S0 to Sn. In this embodiment, it is shown that the number of parameter sets is ‘n+1’ and the number of banks is ‘m+1’. However, the number of parameter sets does not need to be match with the number of banks. The external memory group 54 is accessed on the basis of an access mode which is different for every bank determined by the parameter set selection register 57 or on the basis of the same access mode according to the selection.

In addition, an access mode sequencer 58 and an event trigger register 59 are provided in the memory controller 52. The access mode sequencer 58 is a circuit which holds an access mode change order for every bank beforehand. The access mode is changed in accordance with the order programmed in the access mode sequencer 58. An access mode change timing is informed by writing in the event trigger register 59. Since the event trigger register 59 is used only to detect the access mode change timing, the event trigger register 59 can be substituted to another hardware event.

The memory controller according to the embodiment of the invention is useful for a memory interface that has a plurality of parameters defining the access mode or a plurality of external banks to be accessed, thereby having complicated configuration.

What is claimed is:

1. A memory controller that divides a memory space to be accessed by a CPU into a plurality of banks and accesses each bank on the basis of an access mode determined by a parameter set corresponding to each bank, the memory controller comprising:
a register that selects a parameter set corresponding to each bank from a parameter set register which stores the parameter set in the form of a table capable of being commonly used in each bank, and sets an access mode for each bank.

2. The memory controller according to claim 1,
wherein the register stores an identifier of the parameter set corresponding to each bank.

3. The memory controller according to claim 2,
wherein the register is set in a non-defined area in the memory space.

4. The memory controller according to claim 1,
wherein the number of parameter sets are smaller than the number of banks.

5. The memory controller according to claim 4,
wherein an initial value is the parameter set corresponding to a low speed mode.

6. The memory controller according to claim 1, further comprising:
a ROM that stores a parameter set of which utilization is estimated in advance.

7. The memory controller according to claim 1, further comprising:
a bandwidth detecting circuit that detects an access frequency of the CPU to the bank and selects the parameter set on the basis of the access frequency.

8. The memory controller according to claim 1, further comprising:
a bandwidth detecting circuit that detects an access frequency of the CPU to the bank and changes a set value of the parameter set selection register on the basis of the access frequency.

9. The memory controller according to claim 1, further comprising:
a power saving mode control circuit that, in a power saving mode, selects an access mode corresponding to the power saving mode.

10. The memory controller according to claim 1, further comprising:
an access mode sequencer that holds a sequence for switching an access mode to the bank in accordance with a predetermined event.

11. The memory controller according to claim 10, further comprising:
an event trigger register that detects an event and informs the access mode sequencer of timing for switching the bank.
